(19) United States
(12) Patent Application Publication
(10) Pub. No.: US 2015/0233076 A1
(43) Pub. Date: Aug. 20, 2015

(54) SYSTEM TO DELIVER AND INSTALL PYLONS AND PIPES

(71) Applicant: DEERE & COMPANY, Moline, IL (US)

(72) Inventors: JAMES L. MONTGOMERY, Dubuque, IA (US); Samuel S. Anderson, Franklin, TN (US); Jeffrey M. Stenoish, Asbury, IA (US); Tim Waugh, Dubuque, IA (US)

(21) Appl. No.: 14/607,229

(22) Filed: Jan. 28, 2015

Related U.S. Application Data
(60) Provisional application No. 61/942,361, filed on Feb. 20, 2014.
(60) Provisional application No. 61/941,766, filed on Feb. 19, 2014.

(51) Int. Cl. E02D 7/00; H02S 20/10; E02D 7/18; G05D 1/02; F16L 1/036

(52) U.S. Cl. CPC E02D 7/00; G05D 1/021; F16L 1/036; E02D 7/18; H02S 20/10

(57) ABSTRACT

A method is provided of inserting an elongate element into a ground surface, including drilling at a first drilling location in the ground surface. The drilling is performed by a boring tool of a first vehicle. The elongate element is transported to the first drilling location. The transporting is performed by a second vehicle. The elongate element is handed off from the second vehicle to the first vehicle. The elongate element is inserted into the first drilling location. The inserting is performed by an inserting device of the first vehicle.

### RELATED APPLICATIONS

This application claims priority to U.S. Provisional Patent Application Ser. No. 61/941,766, filed Feb. 19, 2014, and U.S. Provisional Patent Application Ser. No. 61/942,361, filed Feb. 20, 2014, which are hereby incorporated by reference in their entirety.

### FIELD OF THE DISCLOSURE

The present disclosure relates to methods of installing pylons and pipes, and in particular to methods of installing pylons and pipes in an efficient manner.

### BACKGROUND

Presently, large numbers of pylons are installed at defined locations on work sites to support photovoltaic solar panel assemblies and concentrated solar heliostat mirror assemblies. Additionally, large numbers of pipe sections are installed in an assembly at defined locations to construct a pipeline such as used to transport petroleum long distances. The material for these assemblies are commonly distributed in proximity to the final placement of the components and placed on the ground using an over the road truck that is unloaded using a rough terrain fork truck, a four wheel drive loader, or manually.

The components are generally cylinders, I-beams or similar. In the case of solar system installations, the pylons are positioned vertically by hand or with the aid of a skid steer or similar machine at locations that have been marked with pins previously placed in the ground using conventional surveying equipment to locate the pins. Each pylon location is identified on a work site design map. The pylon is driven to the proper depth using a masted impact or vibratory hammer often mounted to a tracked excavator in place of the bucket.

In the case of photovoltaic utility grade power generation systems, solar panel subassemblies are installed manually on the previously installed pylons. In the case of concentrated solar power generation systems, heliostats (e.g., paired mirrors) are installed on the pylons using an off-road crane or similar. In the case of pipe sections used in a pipeline, the sections are handled by modified crawlers, four wheel drive loaders, hydraulic excavators, skid steers, or by hand depending upon the weight of the pipe sections.

In every case, the distribution and manipulation of the components prior to installation require multiple operators and multiple machines. Identification of the installation locations typically requires a surveyor and an additional pass across the work site. Installation of the components typically requires a man on the ground and an operator of the modified excavator.

### SUMMARY

The disclosure may overcome the above-identified problems by performing a combination of several steps with a minimal number of machines by using novel machine forms with unique modifications and installed instrumentation. In one embodiment of the present disclosure, a custom forestry forwarder may be used to transport, distribute and load piles into a vibratory hammer, which may be carried by a crawler. Inter-machine data radio communication can be employed to further coordinate the operation of the group of machines and ultimately be used to automate the crawlers in the system and subsequently eliminate the two crawler operators.

In one aspect of this embodiment, a modified forestry forwarder may deliver and load piles to a pair of pile drivers. The forwarder may feed two modified crawlers operating in succession and in parallel, and each carrying a vibratory hammer. Thus, the system may distribute and install two rows of piles simultaneously in the field. The piles may be in the form of pylons, posts, pipes and other structural components.

The forwarder may be modified with an end-of-arm tool specifically designed to grasp and manipulate cylinders, I-beams, and other structural components. The forwarder may transport the structural components from a single storage area to the point of installation in the field and subsequently place the component into position in the field, or hand the structural component to another machine for component placement. One example of a machine to install the components is a pitch, angle, tile (PAT) crawler modified with a masted auger mounted in place of the ripper and a masted vibratory hammer mounted in place of the three-way mounted blade.

In another aspect of this embodiment, machine position and location instrumentation may be used to locate the machines on a worksite and position the machines with respect to one another. The location instrumentation may include GPS, total station and rotating laser. The machine position instrumentation may include laser range finders, stereo and monocular cameras with displays mounted in the cabs of the machines. Inter-machine communication may be enabled by voice radios and/or data radios.

In yet another aspect of this embodiment, the forwarder may feed a vibratory hammer mounted on an excavator instead of on a crawler.

In a further aspect of this embodiment, a modified forwarder may be used to distribute and handle solar panels which may be mounted on the driven piles.

In one particular embodiment, the present disclosure provides a method of inserting an elongate element into a ground surface, including drilling at a first drilling location in the ground surface. The drilling is performed by a boring tool of a first vehicle. The elongate element is transported to the first drilling location. The transporting is performed by a second vehicle. The elongate element is handed off from the second vehicle to the first vehicle. The elongate element is inserted into the first drilling location. The inserting is performed by an inserting device of the first vehicle.

In another particular embodiment, the present disclosure provides a method of inserting a plurality of elongate elements into a ground surface, including drilling at a plurality of first drilling locations in the ground surface. The drilling at the first drilling locations is performed by a first boring tool of a first vehicle. Drilling is performed at a plurality of second drilling locations in the ground surface. The drilling at the second drilling locations is performed by a second boring tool of a second vehicle. The elongate elements are transported to the first drilling locations and to the second drilling locations by a third vehicle. First ones of the elongate elements are handed off from the third vehicle to the first vehicle, and second ones of the elongate elements are handed off from the third vehicle to the second vehicle. The handing off alternates between handing off a single one of the first elongate elements to the first vehicle, and handing off a single one of the second elongate elements to the second vehicle. The first elongate elements are inserted into respective ones of the first drilling locations by a first inserting device of the first vehicle. The second elongate elements are inserted into respective ones of the second drilling locations by a second inserting device of the second vehicle.

In yet another particular embodiment, the present disclosure provides a method of laying pipe sections into a trench, including excavating the ground to create the trench. The excavating is performed by a first vehicle. The pipe sections are transported to the trench. The transporting is performed by a second vehicle. A first one of the pipe sections is gripped. The gripping is performed by the second vehicle. The one pipe section is deposited into the trench. The depositing includes releasing the one pipe section. The depositing is performed by the second vehicle. The gripping and depositing steps are cyclically repeated for remaining ones of the pipe sections.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a partial perspective view of one embodiment of an arrangement of the disclosure for delivering and installing pylons and pipes;

FIG. 2 is a front perspective view of the forwarder of the arrangement of FIG. 1;

FIG. 3 is a side view of the modified backhoe arm that is mounted on the forwarder of FIG. 2;

FIG. 4 is a perspective view of another embodiment of a forwarder of the disclosure;

FIG. 5 is a perspective view of the boom of the forwarder of FIG. 4;

FIG. 6 is a perspective view of the boom adapter of the forwarder of FIG. 4; and

FIG. 7 is a perspective view of the pipe handler of the forwarder of FIG. 4.

Corresponding reference numerals are used to indicate corresponding parts throughout the several views.

### DETAILED DESCRIPTION

The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure.

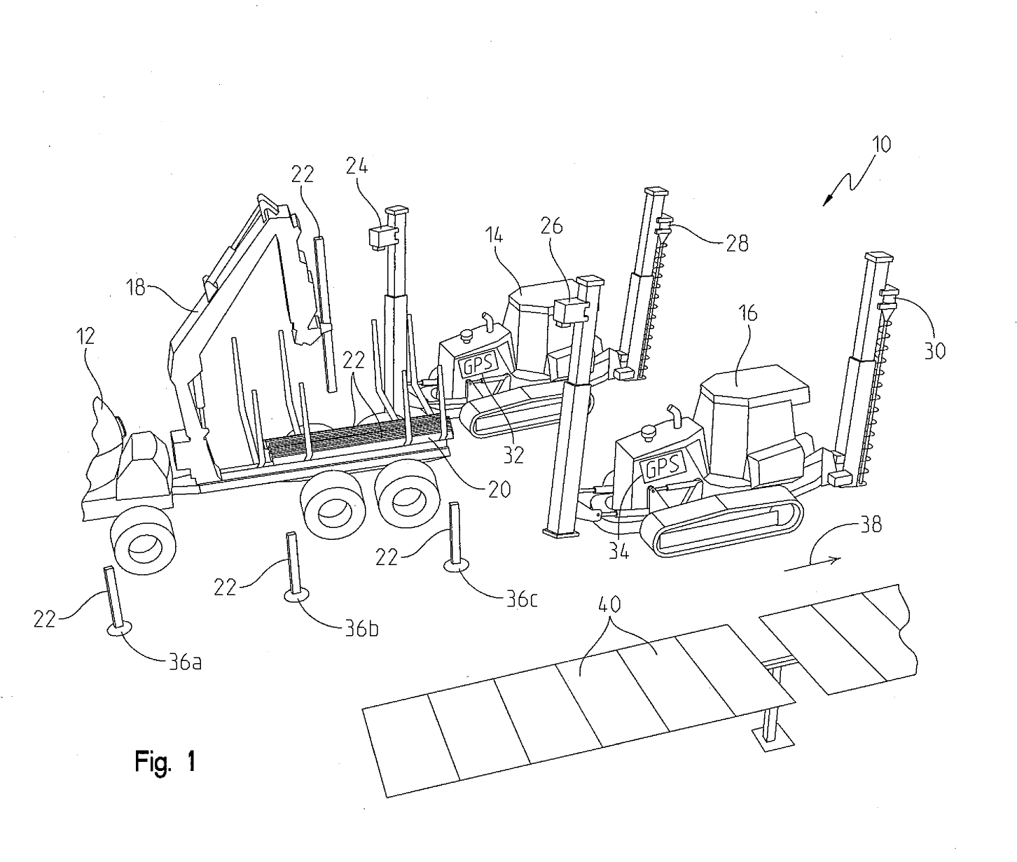

Referring now to the drawings, and particularly to FIG. 1, there is shown one embodiment of an arrangement 10 of the disclosure for delivering and installing pylons, pipes, piles, posts, beams and other types of elongate elements. Arrangement 10 includes three vehicles in the form of a modified forwarder 12 and two modified crawler dozers 14 and 16. Although the disclosure includes these industry-specific forwarder and crawler vehicles, it is to be understood that it is alternatively possible to implement the disclosure with a variety of different vehicles. Forwarder 12 includes a modified backhoe arm 18 and a bunk 20 carrying pipes 22. Crawlers 14, 16 each include a respective inserting tool in the form of a vibratory hammer 24, 26, and a respective boring tool in the form of an auger or drill 28, 30, for example. Crawlers 14, 16 may be modified as compared to a conventional crawler in that the blade of the crawler may be removed and the masted vibratory hammer may be installed on the ball. That is, the vibratory hammer may be mounted onto the ball of a six way pitch angle tilt (PAT) crawler dozer with the blade removed. These modifications may enable lift, pitch and roll adjustment under electro-hydraulic (EH) control. Other modifications to the crawlers may include removing the ripper and installing a masted drill attachment on a modified ripper linkage. That is, a masted boring tool, such as an auger, may be mounted on the rear of the crawler to drill pilot holes for the pylons.

The diameter of the drill or auger may be much larger than the diameter of pipe 22. Drills 28, 30 may be used to loosen the soil into which pipe 22 is to be inserted, and not to evacuate a hole in which to insert pipe 22. Thus, the diameter of drills 28, 30 may be larger than the diameter of pipes 22 in order to make the insertion of pipes 22 into the drilling locations easier. In one embodiment, the diameter of drills 28, 30 is eighteen inches, and the diameter of pipes 22 is six inches. The auger or drill may be called for only in relatively hard soils such as the caliche soils found in the desert north of Las Vegas. In less hard soils, the pylons may be driven directly into the ground without use of a boring tool.

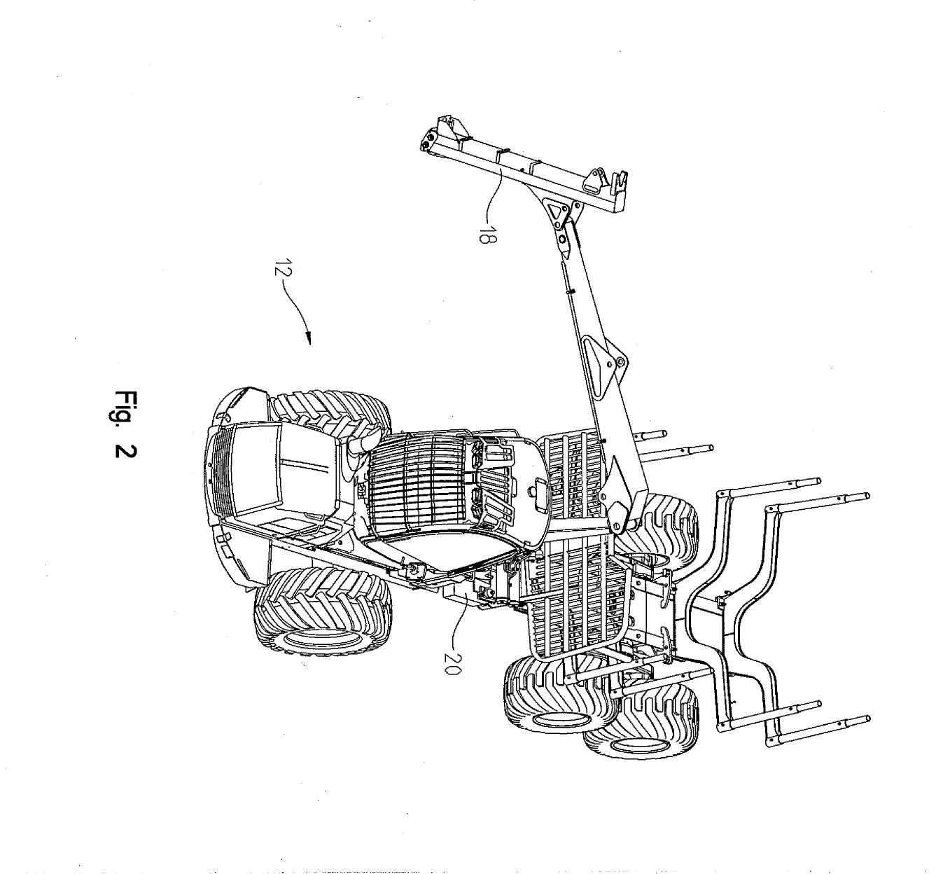

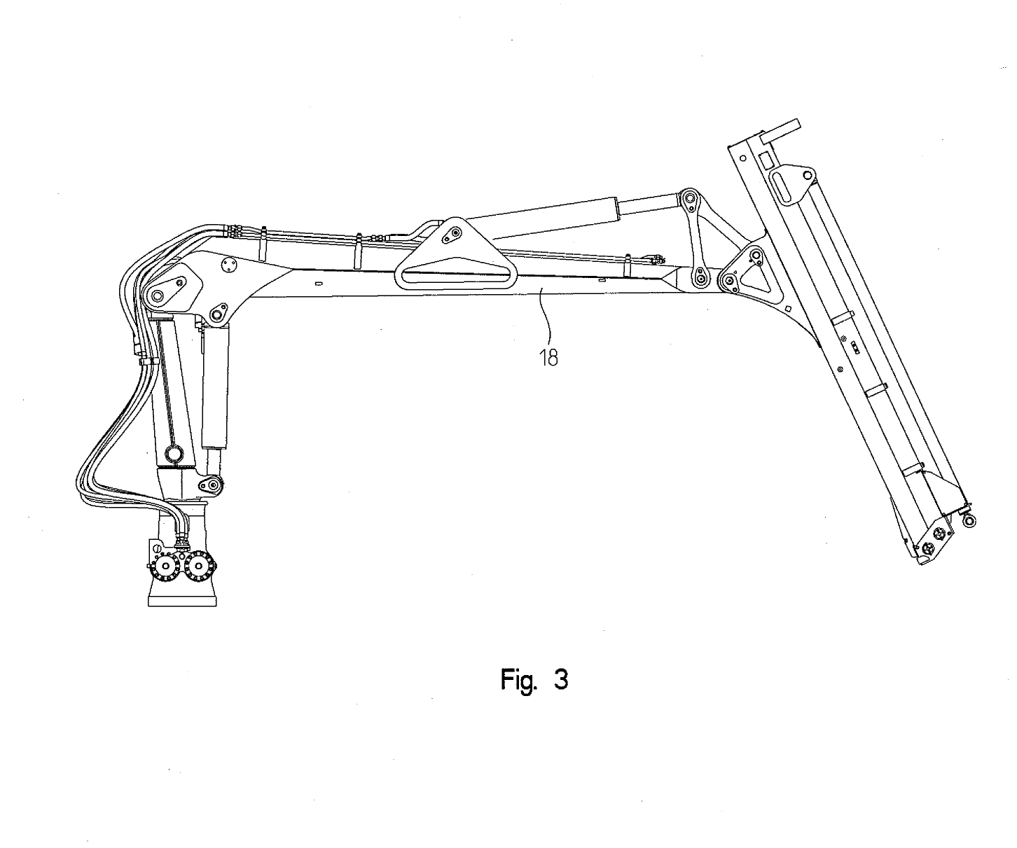

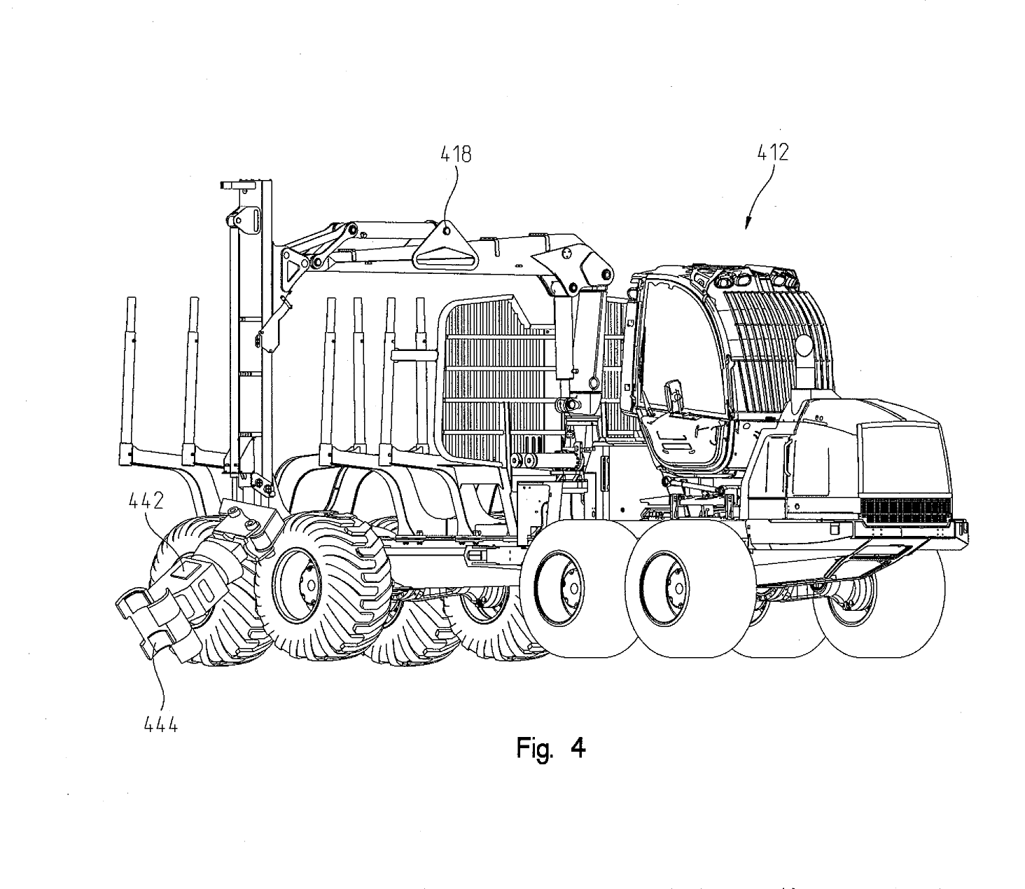

FIG. 2 illustrates another view of forwarder 12, including backhoe arm 18 and bunk 20. FIG. 3 is an enlarged view of backhoe arm 18. As an alternative to the modification to the forwarder arm in the form of an excavator dipper arm that is illustrated in FIG. 3, an attachment may be fitted into a standard forwarder extendable arm supporting a grapple, such as grapple 444 of FIG. 4.

During use, two crawlers may be used along each row of pylons if the rates of boring and driving call for the second crawler. Crawlers 14, 16 may use drills 28, 30 to drill into the ground and loosen the soil in two rows of locations, which may be predetermined and may be located by respective GPS devices 32, 34 (FIG. 1) on crawlers 14, 16. The two modified crawler dozers may be operated in parallel and fed in an alternating sequence by the forwarder. In FIG. 1, only three aligned drilling locations 36a-c drilled by crawler 16 are shown. However, it is to be understood that crawler 14 also drills in a row of drilling locations which may be aligned in a direction 38 parallel to the row defined by locations 36a-c. Each of forwarder 12 and crawlers 14, 16 may travel intermittently in direction 38 in order to arrive at the locations at which locations are drilled and pipes are inserted.

Crawlers 14, 16 may include an electro-hydraulic (EH) enabled closed loop steering feature which enables the crawler to follow a trajectory defined in the site design presented on the display in the crawler. The drill and/or vibratory hammer may converge onto a point and the crawler may halt under automatic control according to a site design using a compact track loader. Thus, the time to converge upon a drilling location may be reduced by half (e.g., from four minutes to two minutes) as compared to the technique in which the operator bumps the excavator tracks back and forth until the proper placement over the drilling location is achieved. Closing the loop on excavator steering may call for EH steering on the excavator.

The forwarder 12 and crawlers 14, 16 may advance in reverse in direction 38 with the auger leading the sequence. The three machines may be advanced under coordinated control using hand signals from the forwarder operator to the crawler operators, or by installing a remote control on the crawlers and triggering preprogrammed motion of the crawlers from the forwarder operator over a data radio link. Thus, the need for crawler operators may be eliminated, thereby reducing the cost of operating the system.

After a drill or auger has drilled at a predetermined location, the same crawler continues in direction 38 until the vibratory hammer arrives in position to insert a pipe into the drilled location. A manipulator arm, or, more specifically, modified forwarder arm 18 grabs one of pipes 22 and, with the corresponding forwarder at a suitable location relative to the crawler, arm 18 hands off pipe 22 to the vibratory hammer. For example, arm 18 may insert one end of pipe 22 into the hammer, and the hammer may then seize pipe 22 before hammering pipe 22 into the drilling location. After thereby servicing one crawler, forwarder 12 may grab another pipe 22 and hand off pipe 22 to the vibratory hammer on the other crawler. The forwarder may hand pylons to each crawler in an alternating sequence. After inserting pipes 22, the crawlers proceed to the next location to be drilled, and the process described above is cyclically repeated for the remaining predetermined drilling locations in the rows.

In one embodiment, the crawlers include an automated steering feature which enables convergence upon a next drilling location with automated stopping. The closed loop steering may use an electrohydraulic hydrostatic transmission with electronic input.

Motion may be initiated, however, by the operator, who may be in the forwarder or in the crawler. Dual axis inertial measurement unit (IMU) electronics may be used to automatically plumb the pile driver (e.g., the vibratory hammer) and to provide convergence motion control controller area network (CAN) commands.

A stereo camera may be advantageously mounted on the bunk of the forwarder to view the grasping of the pylon. Another stereo camera may be mounted on the arm to view the hand off of the pile to the hammer. Yet another stereo camera may be mounted on the frame of the forwarder to view the pile insertion step from the point of view of a man standing on the ground. The graphical display information may be displayed simultaneously in both the forwarder cab and the crawler cab. The specific scenes displayed in the cab may be manually selected by the operator or automatically sequenced by the forwarder logic based upon the present pose of the arm, which indicates the present step in the sequence of events. If there are operators in the crawler, then these operators may benefit from seeing the same viewpoint as the forwarder operator.

In one embodiment, the elongate elements to be inserted into the ground are in the form of I-beam pylons used in photovoltaic utility grade power generation systems. A forestry forwarder may be utilized to transport a load of pylons to the worksite. The pylons may be installed at vector intersections on a rectilinear grid located on a graded surface. The forwarder may be modified with a two axis robotic wrist and gripper to grasp and manipulate the pylons. Remote cameras may be installed on the bunk of the forwarder and on the forwarder arm to enable the operator to view the picking and placing of the pylons. The arm may be used to pick a pylon from the bunk and to hand the pylon off to the masted vibratory hammer.

Each crawler may be fitted with GPS instrumentation augmented by a rotary laser to determine close tolerance height of the pylons above the ground and the designed location according to the worksite map. Each of the forwarder and the crawlers may include an in-cab graphics display. The most current GPS-determined locations of the crawlers may be radio frequency transmitted to the forwarder and displayed in the forwarder cab.

The forwarder may be modified with a one-axis, two-two axis, or three-axis robotic wrist and gripper at the end of the extendable boom section. This wrist and gripper may be used to grasp individual pylons for the forwarder bunk, stand the pylons vertically, and load the pylons into the vibratory hammer. The crawler may be advanced one pylon separation distance and a pilot hole may be drilled at the next predetermined drilling location. While the auger is operating, the forwarder may hand the next pylon to the crawler. The crawler may advance to position the pylon over the previously drilled drilling location. The masted vibratory hammer may provide pitch and roll compliance motion centered around the PAT blade ball to position the pylon vertically in two axes using inclinometer feedback mounted on the mast. The inclinometer may ensure that the pylon is inserted into the ground at the drilling location at about the same vertical angle as the boring tool was drilled into the ground at the drilling location.

The forwarder may be fitted with remote viewing cameras (not shown) on four locations on the bunk to aid the operator in viewing the work piece and the crawler. A fifth camera and laser range finder may be fitted on the forwarder boom arm to aid in the grasping of the pylon and the hand off to the vibratory hammer. The scene of the graphics display in the forwarder may be triggered by the pose of the forwarder arm as the arm is moved through the sequence to automatically provide the operator with the best view. Manual scene selection or view selection is also possible.

In another embodiment, the forwarder carries two cameras. A first camera is mounted on the cab of the forwarder to provide the operator with an advantageous view for grabbing a pylon from the bunk. A second camera is mounted on the boom arm to provide the operator with an advantageous view for the handing off of the pylon to the vibratory hammer. It is also possible for a third camera to be mounted below the bunk or bed of the forwarder and to be pointed in an upwardly tilted direction. This third camera may provide the operator with a good view for mounting solar panels 40 horizontally on top of I-beams or pylons, for example, as illustrated in FIG. 1.

A second forwarder (not shown) may be loaded with photovoltaic solar panel subassemblies in a modified bunk. The second forwarder may follow the first forwarder and the one or two crawlers/excavators. The second forwarder may position and install photovoltaic solar panel subassemblies onto the pylons installed by the first forwarder and the one or two crawlers/excavators.

In a concentrated solar embodiment, heliostat assemblies (not shown) may be loaded onto a modified bunk and the forwarder may position and install the heliostats. In the concentrated solar power installation, the pylons are arranged in concentric circles, with the locations of a number of pylons defining each circle. Adjacent concentric circles may be separated by a radial distance on the order of forty feet. This radial distance may vary with the size of the heliostats or the topography of the worksite. Graded worksites may support more dense packing of the heliostats, and consequently the distance between concentric circles may be smaller. The pylons may support dual mirrors (e.g., heliostats) that focus the sun's energy onto a central point raised on a tower. The heat collected by this concave reflecting assembly may be used to superheat a saline solution and generate steam to power a steam generator.

The pylons used in the concentrated solar installation may be cylindrical and the gripper may be mounted on the wrist of the forwarder arm. The gripper may be designed for grasping the cylindrical surface of the cylindrical pylons. The crawlers may be programmed to follow the circular paths of the concentric circles, and the crawlers may install the pylons on these concentric circles, A second forwarder may transport, handle, position and install the heliostats.

As described herein, two crawlers may be both fed by a single forwarder swinging its boom arm from one side of the bunk to the other opposite side of the bunk to thereby feed the crawlers. The two crawlers may be operated simultaneously to produce two paths with a substantially constant distance between each other at any point along the paths, wherein the paths are each defined by a respective set of elongate elements inserted into the ground in either a substantially vertical orientation or a substantially horizontal orientation. The paths are described herein as being either linear or circular. However, it is to be understood that it is also within the scope of the disclosure for the paths to be other than linear or circular, such as paths that zig-zag or are serpentine, for example.

In an embodiment in which a forwarder is used to lay sections of pipe horizontally in the ground, the bunk on the forwarder may be modified to receive cylindrical pipe sections. The width of the bunker may vary with the diameter of the pipe sections. An excavator or rotary trenching machine may be used to excavate the trench that is to contain the pipeline. A robotic wrist and gripper sized for the diameter of the pipe sections may be mounted on the forwarder. The wrist and gripper may connect the pipe section to the pipe section that was immediately previously laid. The forwarder may be loaded with pipe sections and used to transport, handle and install the pipe sections. GPS receivers may be mounted to the bunk on the forwarder to locate and orient the machine along the pipeline trench. Encoding devices, such as the devices marketed by MTS Systems Corporation and presently used on forwarders in forestry applications may be installed in each of the hydraulic cylinders used on the forwarder arm and wrist. The extension of the cylinders along with the rotation of the boom about the mount on the forwarder frame may be used to calculate the orientation and position (e.g., three-dimensional offset) of the forwarder boom with respect to the bunk and the pair of GPS antennas. A combination laser range finder and camera may be mounted to the forwarder boom to locate the pipe section joints and to capture images of the pipes as they are placed in the trench. It is common while laying pipelines for the pipe joint weld and test data to be hand written on the pipe as the sections are assembled. A surveyor or supervisor is then tasked with recording these notes in a notebook for record keeping. The camera and laser range finder mounted on the forwarder arm may enable recording of the joint, the notes, and the latitude, longitude and elevation of the intersection of the sections of pipe.

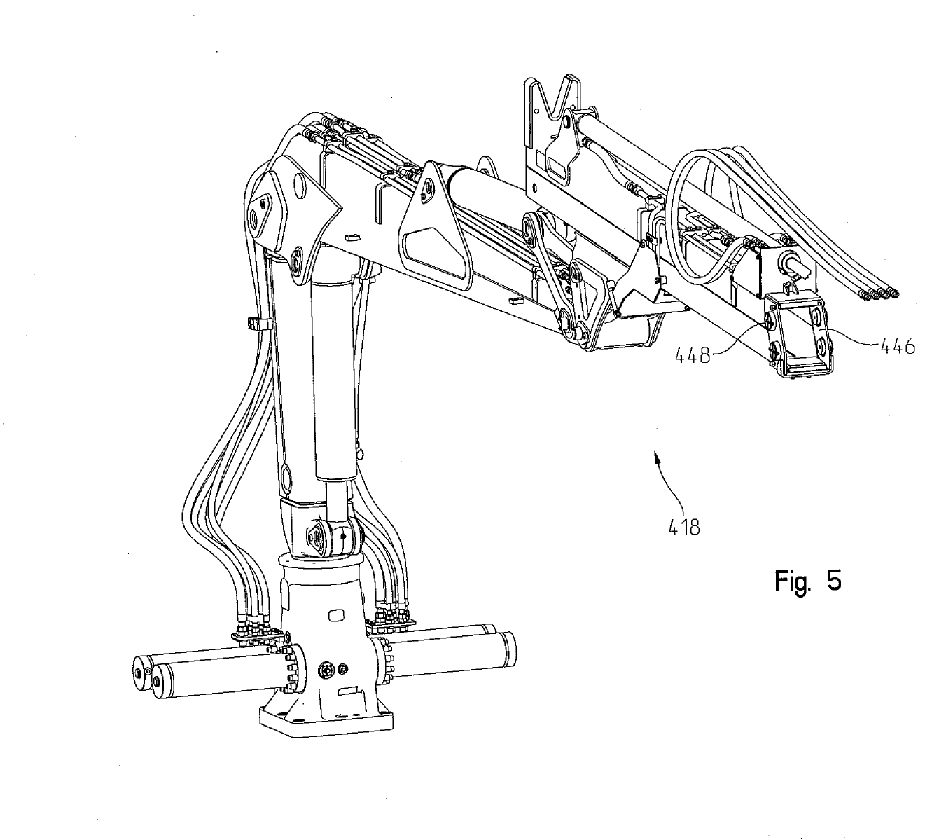

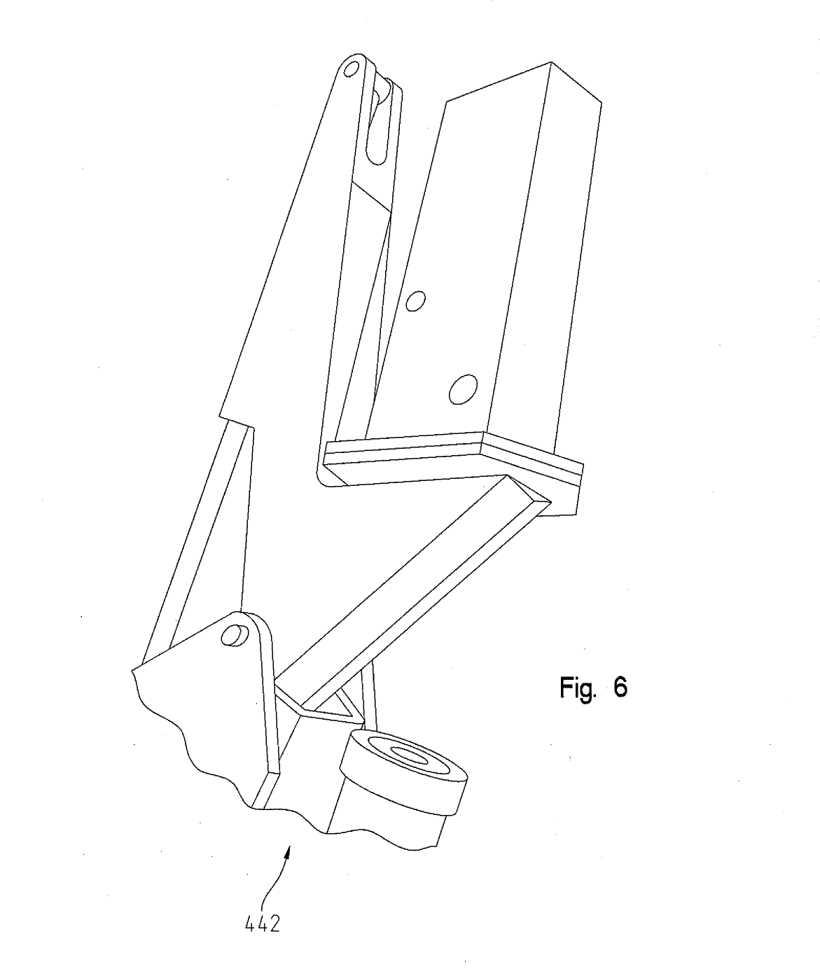

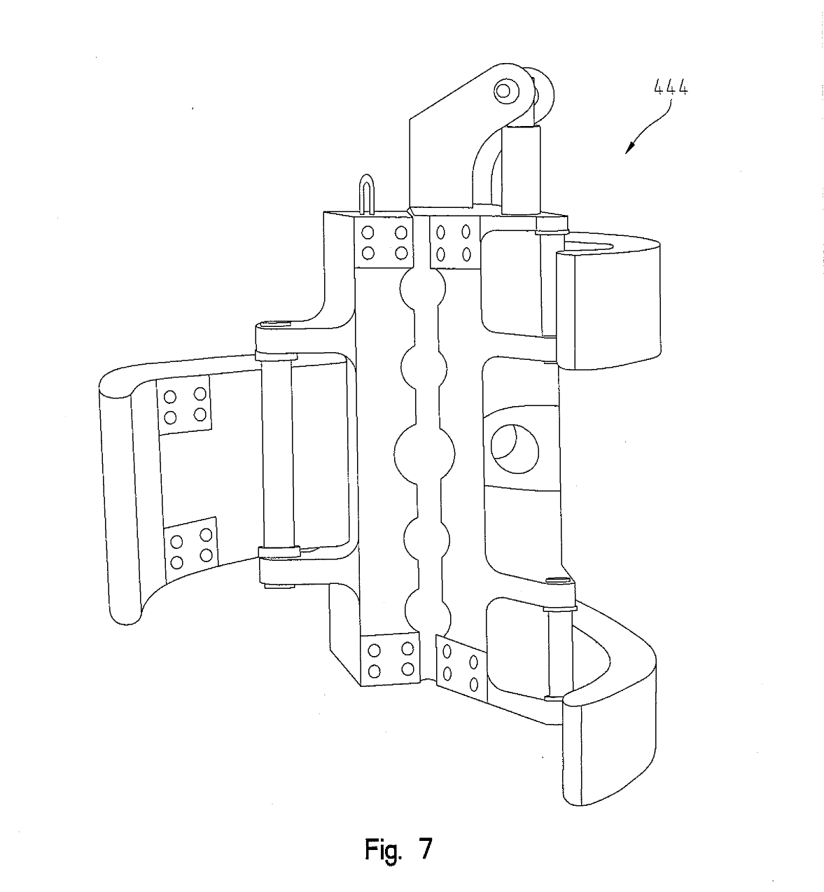

Another embodiment of a forwarder 412 of the disclosure is illustrated in FIG. 4, including a boom 418, a scaled down boom adapter 442 and a pipe handler attachment 444. Pipe handler attachment 444 may be similar to pipe handler attachments marketed by Rotobec Inc. of Quebec, Canada. Boom 418, boom adapter 442 and pipe handler attachment 444 are shown in more detail in FIGS. 5-7, respectively. Boom adapter 442 may be installed in boom end 446 (FIG. 5). Holes may be drilled in boom end 446, as shown at 448, in order to securely attached boom adapter 442 to boom 418.

Although the disclosure above describes a modified backhoe arm, as shown in FIG. 3, it is to be understood that it is not necessary within the scope of the disclosure to use a modified backhoe arm. In another embodiment, the conventional arm of a forwarder is modified by replacing the free hanging grapple with a three axis grapple that fits into an unmodified boom section on the forwarder. This is advantageous as it involves only a small modification of the forwarder, and the forwarder may be refitted with the original grapple and used in the forest in a second stage of the forwarder's life. Moreover, the crawler may also be refitted for a second stage of its life. Advantageously, the vibratory hammer attachment and the boring tool do not require modification of the base crawler machine. The original blade and ripper may be easily reinstalled on the crawler machine for use in more conventional applications. Thus, both the forwarder and crawler may have high resale values as the material handling operations of the present disclosure do not place as much load on the base machines as do conventional forestry and earth moving operations. The forwarder and crawler machines used in the material distribution and assembly applications of the present disclosure would not experience severe wear.

The present disclosure may also be applied to the installation of fence posts. Systems similar to those described above may be mounted onto smaller crawlers or compact track loaders in order to perform fence installation using substantially the same control architecture as described above.

The present disclosure may also be applied to the planting of trees or potted plants. That is, techniques similar to those described above may be applied to the landscaping business for planting large numbers of trees or potted plants that are commonly described in a computer aided design (CAD)/geographic information system (GIS) design. The forestry industry could use the apparatus and methods described herein in planting forest plantations in regular patterns.

While embodiments incorporating the principles of the present disclosure have been described hereinabove, the present disclosure is not limited to the described embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A method of inserting an elongate element into a ground surface, the method comprising the steps of:
drilling at a first drilling location in the ground surface, the drilling being performed by a boring tool of a first vehicle;
transporting the elongate element to the first drilling location, the transporting being performed by a second vehicle;
handing off the elongate element from the second vehicle to the first vehicle; and
inserting the elongate element into the first drilling location, the inserting being performed by an inserting device of the first vehicle.

2. The method of claim 1, wherein the boring tool is forward of the inserting device relative to a traveling direction, the method comprising the further step of moving the first vehicle from a first position along the traveling direction to a second position along the traveling direction, the moving being performed between the drilling step and the inserting step.

3. The method of claim 2, wherein the boring tool and the inserting device are substantially aligned along the traveling direction.

4. The method of claim 2, wherein the moving step includes automatically steering the first vehicle and converging the inserting device upon the first drilling location.

5. The method of claim 4, comprising the further step of triggering the converging by transmitting a radio frequency signal from the second vehicle to the first vehicle, the transmitting being initiated by an operator of the second vehicle.

6. The method of claim 2, comprising the further step of moving the first vehicle from the second position to a third position along the traveling direction, the moving to the third position being performed after the inserting step and including automatically steering the first vehicle and converging the boring tool upon a second drilling location.

7. The method of claim 6, comprising the further step of triggering the converging by transmitting a radio frequency signal from the second vehicle to the first vehicle, the transmitting being initiated by an operator of the second vehicle.

8. The method of claim 1, wherein the boring tool and the inserting device are disposed at opposite ends of the first vehicle.

9. The method of claim 1, wherein the second vehicle includes a boom arm, the handing off step including using the boom arm to grab and lift the elongate element.

10. The method of claim 9, wherein the inserting device comprises a vibratory hammer, the handing off step including using the boom arm to couple the elongate element to the vibratory hammer.

11. The method of claim 1, comprising the further steps of:
transporting a solar panel to the first drilling location, the transporting being performed by a third vehicle; and
mounting the solar panel on the elongate element, the mounting being performed by the third vehicle.

12. The method of claim 1, comprising the further steps of:
mounting a first stereo camera on a bunk of the second vehicle;
mounting a second stereo camera on an arm of the second vehicle;
mounting a third stereo camera on a frame of the second vehicle;
mounting a laser range finder on the arm of the second vehicle; and
automatically selecting an image captured by the first stereo camera, the second stereo camera, or the third stereo camera to be displayed within a cab of the second vehicle, the selecting being dependent upon a position of the arm of the second vehicle.

13. The method of claim 12, comprising the further step of displaying the selected image within a cab of the first vehicle at a same time at which the image is displayed within the second vehicle.

14. A method of inserting a plurality of elongate elements into a ground surface, the method comprising the steps of:
drilling at a plurality of first drilling locations in the ground surface, the drilling being performed by a first boring tool of a first vehicle;
drilling at a plurality of second drilling locations in the ground surface, the drilling being performed by a second boring tool of a second vehicle;
transporting the elongate elements to the first drilling locations and the second drilling locations, the transporting being performed by a third vehicle;
handing off first ones of the elongate elements from the third vehicle to the first vehicle, and handing off second ones of the elongate elements from the third vehicle to the second vehicle, the handing off alternating between handing off a single one of said first elongate elements to the first vehicle and handing off a single one of said second elongate elements to the second vehicle;
inserting the first elongate elements into respective ones of the first drilling locations, the inserting of the first elongate elements being performed by a first inserting device of the first vehicle; and
inserting the second elongate elements into respective ones of the second drilling locations, the inserting of the second elongate elements being performed by a second inserting device of the second vehicle.

15. The method of claim 14, wherein the first drilling locations define a first path and the second drilling locations define a second path, the first path and the second path being separated by a substantially constant distance along their lengths.

16. The method of claim 15, wherein the first path and the second path form concentric circles.

17. The method of claim 15, wherein the first path and the second path are substantially linear and parallel.

18. The method of claim 14, wherein the third vehicle includes a boom arm, the handing off step including using the boom arm to grab and lift the first elongate elements and the second elongate elements.

19. The method of claim 18, wherein the third vehicle includes a bunk carrying the first elongate elements and the second elongate elements, the step of handing off first ones of the elongate elements from the third vehicle to the first vehicle including swinging the boom arm to a first side of the bunk, and the step of handing off second ones of the elongate elements from the third vehicle to the second vehicle including swinging the boom arm to a second side of the bunk, the first side of the bunk being opposite the second side of the bunk.

20. The method of claim 14, wherein the first vehicle and the second vehicle each alternate between performing a drilling step at a single said drilling location and performing an inserting step for a single said elongate element.

21. A method of laying pipe sections into a trench, the method comprising the steps of:
excavating the ground to create the trench, the excavating being performed by a first vehicle;
transporting the pipe sections to the trench, the transporting being performed by a second vehicle;
gripping a first one of the pipe sections, the gripping being performed by the second vehicle;
depositing the one pipe section into the trench, the depositing including releasing the one pipe section, the depositing being performed by the second vehicle; and
cyclically repeating the gripping and depositing steps for remaining ones of the pipe sections.

22. The method of claim 21, wherein the second vehicle includes a boom arm, the gripping step including using the boom arm to grab and lift the one pipe section.

23. The method of claim 22, wherein the second vehicle includes a bunk carrying the pipe sections, the gripping step including using the boom arm to grab and lift the one pipe section from the bunk.

24. The method of claim 23, wherein the boom arm is connected to a pipe handler attachment, the gripping step being performed by the pipe handler attachment.

25. The method of claim 24, wherein the boom arm is attached to a boom adapter, the boom adapter interconnecting the boom arm and the pipe handler attachment.

26. The method of claim 21, comprising the further step of attaching the one pipe section to a previously deposited said pipe section, the attaching being performed by the second vehicle.
